(19) United States
(12) Patent Application Publication
(10) Pub. No.: US 2005/0087624 A1
(43) Pub. Date: Apr. 28, 2005

(54) Injector for fuel injection

(75) Inventor: Martin Neumaier, Regensburg (DE)

Correspondence Address: Andreas Grubert;Baker Botts L.L.P., One Shell Plaza, 910 Louisiana, Houston, TX, 77002-4995, US

(73) Assignee: Siemens Aktiengesellschaft

(21) Appl. No.: 10/984,060

(22) Filed: Nov. 9, 2004

Related U.S. Application Data
(63) Continuation of application No. PCT/DE03/01448, filed on May 6, 2003.

(30) Foreign Application Priority Data
May 10, 2002 (DE) 10220931.6

(51) Int. Cl. F02M 59/00

(52) U.S. Cl. 239/533.2

(57) ABSTRACT

An injector for injecting fuel into a combustion chamber in an internal combustion engine comprises an injector body (2), an injector needle (3) and a control device (13) in order to control pressure in a control chamber (4) for actuating the injector needle. The injector also comprises a supply throttle (6) and a discharge throttle (7) which are fluidically connected to the control chamber (4). The discharge throttle (7) and the supply throttle (6) are arranged in a throttle module (5) embodied as a separate component.

### CROSS REFERENCE TO RELATED APPLICATION

This application is a continuation of copending International Application No. PCT/DE03/01448 filed May 6, 2003 which designates the United States, and claims priority to German application no. 102 20 931.6 filed May 10, 2002.

### TECHNICAL FIELD OF THE INVENTION

The present invention relates to an injector for injecting fuel into a combustion chamber of an internal combustion engine.

### DESCRIPTION OF THE RELATED ART

Different types of fuel injectors are known e.g. for common rail systems. An injector of conventional construction comprises a nozzle needle which is connected indirectly via a plunger, or directly, to a control chamber to which pressure is applied. If the nozzle and control chamber are at equal pressure, a resulting force is generated by the geometrically defined ratio of the surfaces on which the pressure is acting. If, for example, the surface area at the nozzle is smaller than the area at the plunger, a resulting force is generated which presses the nozzle needle into its seat, thereby closing the nozzle.

The control chamber is connected via a so-called fill port to a region of high pressure from an accumulator (rail) which is simultaneously also routed to the nozzle. The control chamber is further connected to a limiting valve via a so-called spill port. As the spill port has a larger flow cross section than the fill port, the opening of the limiting valve causes the pressure in the control chamber to drop. This pressure drop in the control chamber causes the resulting force at the nozzle needle to change so that the nozzle needle lifts from its seat and fuel can flow out through the injection bores into a combustion chamber of the internal combustion engine. In prior art injectors, it has been the practice to incorporate the control chamber and the fill port or spill port in the injector housing in each case, with the result that the injector body is of relatively complicated construction and is relatively complicated to manufacture in production engineering terms, as a large number of operations must be performed on the injector body.

### SUMMARY OF THE INVENTION

An object of the present invention is, therefore, to provide an injector for injecting fuel that can be used particularly in a common rail system, is of simple construction and can be inexpensively manufactured.

This and other objects can be achieved by an injector for injecting fuel into a combustion chamber of an internal combustion engine, comprising an injector body, a nozzle needle, a control device in order to control a pressure in a control chamber for actuating the nozzle needle, a fill port and a spill port both of which are fluidically connected to the control chamber, wherein the fill port and the spill port are disposed in a porting module implemented as a separate component.

In the porting module a resetting element can be disposed for resetting the control device. In the porting module a recess can be formed which provides at least a sub-region of the control chamber. The fill port can be disposed in the radial direction of the injector. Between the injector body and the porting module an annular gap can be implemented via which fuel is supplied to the fill port. The annular gap can be sealed in the axial direction of the injector. The seal can be achieved by means of cutting edges. The porting module can be disposed in a stepped bore having at least two steps of the injector body, wherein the annular gap being sealed in the axial direction at the steps of the stepped bore. The annular gap can be sealed in the radial direction of the injector. The sealing can be performed by an elastic seal and/or a press fit between the porting module and the injector body.

The injector according to the invention is designed in such a way that a fill port and a spill port are provided in a porting module implemented as a separate component. Disposing the two ports in a separate component enables manufacturing advantages to be achieved, as the ports which must be manufactured with a particularly high degree of accuracy can be inserted in the separate component in a readily accessible manner. The porting module is then mounted in the injector.

It is further preferred to dispose in the separate porting module a resetting element, e.g. a helical spring, for resetting the control device of the injector, thereby enabling the injector according to the invention to be of more compact design.

More advantageously there is formed, in the separate porting module, a recess which provides at a sub-region of the injector control chamber, thereby enabling the injector according to the invention to be implemented even more compactly in the axial direction. In order to provide an even more compact injector, the fill port is preferably disposed in the radial direction relative to the injector axis, it being particularly preferred that the fill port be supplied with pressurized fuel via an annular gap disposed between the injector body and the separate porting module.

In order to achieve tight sealing of the annular gap between the injector body and the separate porting module, the annular gap is preferably sealed in the axial direction, it being particularly preferred that the sealing be achieved using cutting edges which, during assembly, undergo plastic deformation or cause plastic deformation in the other component so as to provide a tight seal.

It is particularly preferred that the porting module be disposed in a stepped bore of the injector body with at least two steps, the annular gap being sealed at the steps of the stepped bore in the axial direction. In the case of sealing by means of cutting edges, said cutting edges can be implemented either in the porting module or at the steps in the injector body.

Another possible means of sealing the annular gap between the injector body and the porting module is to provide sealing in the radial direction of the injector, said radial sealing being provided e.g. by means of an elastic ring seal or a press fit.

It should be noted, moreover, that it is obviously also possible to provide a seal between the injector body and the separate porting module both in the axial direction and in the radial direction.

### BRIEF DESCRIPTION OF THE DRAWINGS

The invention will now be described with reference to a preferred embodiment in conjunction with the accompanying drawing.

The single FIGURE shows a schematic sectional view of a region of an injector incorporating the porting module according to the invention.

### DETAILED DESCRIPTION OF THE PREFERRED EMBODIMENTS

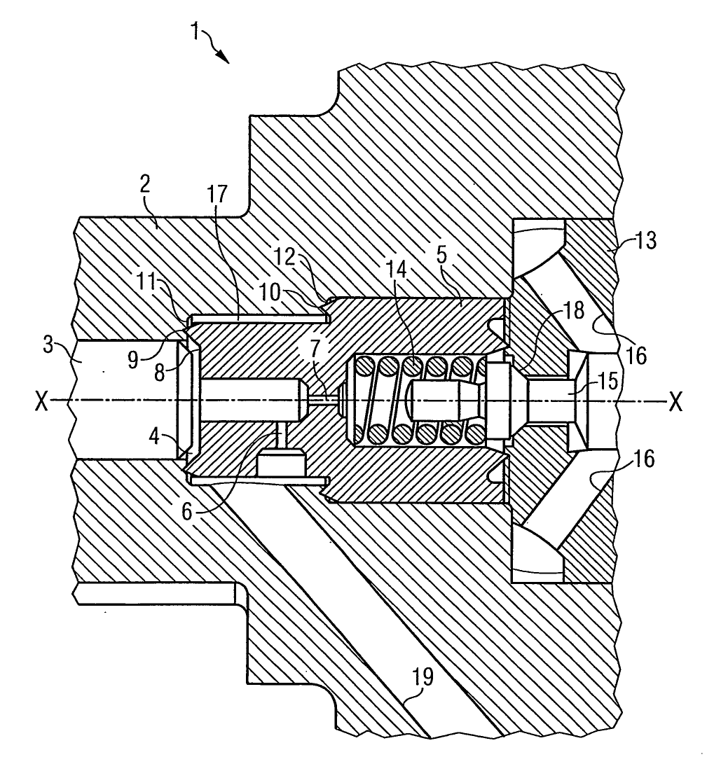

As FIG. 1 shows, the injector 1 comprises an injector body 2 in which there are disposed a porting module 5 and a control module 13. Additionally disposed in the injector body 2 is a nozzle needle 3 guided in the axial direction X-X of the injector in the injector body 2. The porting module 5 is implemented as a separate component. A fill port 6 and a spill port 7 are implemented in the porting module 5. There is additionally formed a U-section recess 8 at the end of the porting module 5 facing the nozzle needle 3. This recess 8 provides a control chamber 4 between the porting module 5 and the nozzle needle 3. The control module 13 comprises a valve 15 which can be actuated via a control unit (not shown) such as a magnetic element or a piezo actuator. The valve 15 closes or uncovers a valve seat 18 formed on the control module 13. The valve 15 is reset by means of a resetting spring 14 implemented as a helical spring. In the control module 13 there are additionally provided two return flow lines 16 which provide a connection to a vehicle fuel tank (not shown).

As can be further seen from FIG. 1, the spring 14 is disposed in a recess formed in the porting module 5, thereby allowing a very compact design in the axial direction X-X of the injector 1.

As FIG. 1 additionally shows, pressurized fuel is fed to the fill port 6 via a fuel supply line 19 and an annular gap 17 formed between the injector body 2 and the porting module 5.

As the porting module 5 is implemented as a separate component, a seal must be implemented between the porting module 5 and the injector body 2. As shown in FIG. 1, the porting module 5 is disposed in a stepped bore of the injector body, said bore comprising a first step 11 and a second step 12. In this embodiment, the annular gap 17 is sealed in the axial direction X-X of the injector 1. This seal is provided by a first cutting edge 9 and a second cutting edge 10 which are formed at shoulders of the porting module 5 which correspond to the steps 11, 12 of the stepped bore.

When the porting module 5 is mounted in the injector body 2, plastic deformation of the cutting edges 9 and 10 takes place at the steps 11 and 12 of the stepped bore, causing the surfaces of the two components 2 and 5 to mate in an ideal manner, thereby providing a very good seal. This seal remains tight even at the very high pressures obtaining e.g. in common rail injection systems. In addition, by providing the plastically deforming cutting edges 9 and 10, the manufacturing-induced length differences between the spacings of the steps 11, 12 of the stepped bore and/or the spacings of the shoulders formed on the porting module 5 between the cutting edges 9 and 10 can be compensated. This makes it possible for the manufacturing tolerances to be less tightly selected, thereby enabling the injector to be manufactured more cheaply. Moreover, by providing the porting module 5 as a separate individual component, the bores for the fill port 6 and the spill port 7 can be implemented quickly, easily and with a high degree of accuracy. Likewise the cutting edges 9, 10 provided on the porting module 5 can be produced very inexpensively, e.g. by turning.

The injector 1 according to the invention operates as follows. When fuel is to be injected, the valve 15 is operated via an actuator (not shown) and moved in the direction of the nozzle needle 3 so that the valve 15 lifts from its valve seat 18, thereby opening a connection between the control chamber 4 via the drain port 7 and the open valve 15 to the return the flow line 16. This causes the pressure in the control chamber 4 to fall so that the nozzle needle 3 moves into the control chamber 4 in the axial direction X-X of the injector, causing the nozzle needle 3 to lift from its seat so that at least one nozzle is uncovered and fuel is injected by the nozzle into a combustion chamber of an internal combustion engine, the injection lasting as long as the valve 15 remains in its open state. The opening of the valve 15 takes place against the spring force of the spring 14.

When injection is to be terminated, the valve 15 is again operated via an actuator so that it returns to its starting position, in which the valve seat 18 is closed, by resetting of the spring 14, thereby again interrupting the connection between the control chamber 4 and the return flow line 16 so that the original pressure can build up in the control chamber 4, as pressurized fuel is supplied via the fill port 6. This causes the nozzle needle 3 to return to its starting position and close the injector nozzle, thereby terminating fuel injection.

During actuation of the control valve 15 and of the nozzle needle 3, continuously tight sealing of the annular gap 17 between the injector module 2 and the porting module 5 can be ensured at the steps 11 and 12 respectively of the injector body 2. It should be noted that the cutting edges 9, 10 are obviously not only provided in the porting module 5 but that cutting edges can also be provided in the same way at the steps 11, 12 of the injector body which become plastically deformed when the porting module 5 is mounted, thereby producing a seal between the injector body 2 and the porting module 5.

The present invention therefore relates to an injector for injecting fuel into a combustion chamber of an internal combustion engine. The injector comprises an injector body 2, a nozzle needle 3 and a control device 13 in order to control a pressure in a control chamber 4 for actuating the nozzle needle 3. The injector 1 additionally comprises a fill port 6 and a spill port 7 which are fluidically connected to the control chamber 4, said fill port 6 and said spill port 7 being disposed in a porting module 5 implemented as a separate component.

The above description of the exemplary embodiment according to the present invention is used for illustrative purposes only and is not to be taken in a limiting sense. Within the scope of the invention, various changes and modifications are possible without departing from the scope of the invention and its equivalents.

1. An injector for injecting fuel into a combustion chamber of an internal combustion engine, comprising an injector body, a nozzle needle, a control device in order to control a pressure in a control chamber for actuating the nozzle needle, a fill port and a spill port both of which are fluidically connected to the control chamber, wherein the fill port and the spill port are disposed in a porting module implemented as a separate component.

2. The injector according to claim 1, wherein in the porting module a resetting element is disposed for resetting the control device.

3. The injector according to claim 1, wherein in the porting module a recess is formed which provides at least a sub-region of the control chamber.

4. The injector according to claim 1, wherein the fill port is disposed in the radial direction of the injector.

5. The injector according to claim 4, wherein between the injector body and the porting module an annular gap is implemented via which fuel is supplied to the fill port.

6. The injector according to claim 5, wherein the annular gap is sealed in the axial direction of the injector.

7. The injector according to claim 6, wherein the seal is achieved by means of cutting edges.

8. The injector according to claim 6, wherein the porting module is disposed in a stepped bore having at least two steps of the injector body, the annular gap being sealed in the axial direction at the steps of the stepped bore.

9. The injector according to claim 1, wherein the annular gap is sealed in the radial direction of the injector.

10. The injector according to claim 9, wherein the sealing is performed by an elastic seal and/or a press fit between the porting module and the injector body.

11. An injector for injecting fuel into a combustion chamber of an internal combustion engine, comprising:
an injector body,
a nozzle needle,
a control device for controlling a pressure in a control chamber for actuating the nozzle needle, and
a fill port and a spill port both of which are fluidically connected to the control chamber and are disposed in a porting module implemented as a separate component.

12. The injector according to claim 11, wherein the porting module comprises a resetting element for resetting the control device.

13. The injector according to claim 11, wherein the porting module comprises a recess which provides at least a sub-region of the control chamber.

14. The injector according to claim 11, wherein the fill port is disposed in the radial direction of the injector.

15. The injector according to claim 14, comprising an annular gap between the injector body and the porting module via which fuel is supplied to the fill port.

16. The injector according to claim 15, wherein the annular gap is sealed in the axial direction of the injector.

17. The injector according to claim 16, wherein the seal is achieved by means of cutting edges.

18. The injector according to claim 16, wherein the porting module is disposed in a stepped bore having at least two steps of the injector body, the annular gap being sealed in the axial direction at the steps of the stepped bore.

19. The injector according to claim 11, wherein the annular gap is sealed in the radial direction of the injector.

20. The injector according to claim 19, wherein the sealing is performed by an elastic seal and/or a press fit between the porting module and the injector body.
